(19) United States
(12) Patent Application Publication
(10) Pub. No.: US 2015/0195231 A1
(43) Pub. Date: Jul. 9, 2015

(54) System and Method for Avoiding Loops in Automatic Message Processing

(71) Applicants: Nahush Mahajan, Sunnyvale, CA (US); Jeffrey B. Stewart, San Leandro, CA (US); Darick M. Tong, Palo Alto, CA (US)

(72) Inventors: Nahush Mahajan, Sunnyvale, CA (US); Jeffrey B. Stewart, San Leandro, CA (US); Darick M. Tong, Palo Alto, CA (US)

(21) Appl. No.: 13/179,289

(22) Filed: Jul. 8, 2011

Related U.S. Application Data
(62) Division of application No. 10/957,548, filed on Sep. 30, 2004, now abandoned.

(51) Int. Cl. H04L 12/58

(52) U.S. Cl. CPC H04L 51/18

(57) ABSTRACT

Loop avoidance information is added to messages to determine whether a messaging application had previously processed a message. Loop avoidance information can be added to messages as they are received in an added header field (such as a message identifier and user identifier) prior to storage. The information can be signed by the inserting application. If the application sees the information in the header of a subsequently received message, appropriate action may be taken to abort processing of the message. This is particularly useful in downloading from POP accounts. Similar loop avoidance information (which might include the destination address) can be added as a message is being automatically forwarded. In a subsequent forwarding, the application could determine that it had previously forwarded the message and should abort the current forwarding. The loop avoidance information can be stored locally for subsequent fast look up.

### RELATED APPLICATIONS

This application is a divisional of U.S. application Ser. No. 10/957,548, filed Sep. 30, 2004, which is incorporated herein by reference in its entirety.

### TECHNICAL FIELD

The present invention relates generally to processing of messages, and in particular to detecting and avoiding loops in automatic message processing.

### BACKGROUND

Many electronic messaging applications provide an automatic routing feature. An automatic routing feature enables a user to have the messaging application forward messages to specified destinations when certain conditions are satisfied. For example, a user may set up an automatic forwarding rule such that when a message is received from a particular source address, the message is automatically forwarded to a particular destination address.

Unfortunately, a user or series of users can inadvertently or maliciously set up loops of automatic forwarding that can drain precious network resources. For example, user A may have a rule to forward messages to B, B may have a rule which forwards messages to C, and C may have a rule that forwards messages to A. A message caught in this loop might circulate indefinitely unless caught, stopped or the system fails due to resource exhaustion.

Loops can also occur within systems using mail store protocols such as the Post Office Protocol (POP) and the Internet Message Access Protocol (IMAP). Because client messaging systems may not have sufficient resources to keep a messaging system up, running and connected at all times to the server, these protocols allow a client to retrieve mail from a mail server for subsequent off-line processing. Version 3 of POP (POP3), for example, is designed to allow a client (such as a personal computer, PDA or workstation) to dynamically access a maildrop on a server implementing POP3. If POP3 retrieval is used in conjunction with automatic forwarding or routing in the client messaging application, however, loops may result. For example, a client message program may be set up to automatically download messages from particular user account on a POP server every 15 minutes; a client message program may be set up to forward incoming messages to a user account on the POP3 server. If the address of the POP3 account to which the messages are being automatically forwarded is the same as the address from which the messages are being retrieved a loop will result: every message that the client retrieves from the account will be automatically forwarded back to the account, which is in turn retrieved by the client program, and so on.

Loops can also be created with combinations of automatic forwarding and POP3 access. For example, a user A client account could be configured to download messages from a POP3 account and the user A client account could also be configured to automatically forward received messages to a second account, such as a user B. If the user B account automatically forwards the message to user A, a loop will result.

It would be desirable to provide techniques to block and/or prevent loops created by automatic message forwarding and/or retrieval features.

### SUMMARY

According to one embodiment, a method of avoiding message forwarding loops includes under control of a message client system, retrieving from a message server a first portion of a message stored at the message server. The existence of loop avoidance information previously created by the message client system in the first portion is determined and a second portion of the message is retrieved when a first condition is satisfied and not retrieving the second portion of the message when a second condition is satisfied.

### BRIEF DESCRIPTION OF THE DRAWINGS

The aforementioned features and advantages of the invention as well as additional features and advantages thereof will be more clearly understood hereinafter as a result of a detailed description of embodiments of the invention when taken in conjunction with the drawings. Like reference numerals refer to corresponding parts throughout the several views of the drawings.

FIG. 1 illustrates a configuration in accordance with embodiments of the present invention.

FIG. 2 illustrates another configuration in accordance with embodiments of the present invention.

FIG. 3 illustrates one type of loop situation in accordance with embodiments of the present invention.

FIG. 4 illustrates another type of loop situation in accordance with embodiments of the present invention.

FIG. 5 illustrates a process for adding loop avoidance information in accordance with embodiments of the present invention.

FIG. 6 illustrates the process of FIG. 5 in more detail in accordance with embodiments of the present invention.

FIG. 7 illustrates a process for processing a message with loop avoidance information in accordance with embodiments of the present invention.

FIG. 8 illustrates a process for processing a message with loop avoidance information in accordance with embodiments of the present invention.

FIG. 9 illustrates a process for adding loop avoidance information in accordance with embodiments of the present invention.

FIG. 10 illustrates a process for adding loop avoidance information in accordance with embodiments of the present invention.

FIG. 11 illustrates a process for processing message with loop avoidance information in accordance with embodiments of the present invention.

FIG. 12 illustrates a system for processing messages with loop avoidance information in accordance with embodiments of the present invention.

### DESCRIPTION OF EMBODIMENTS

Loops created by automatic forwarding can be blocked and/or prevented by inserting information into received messages or to messages as they are forwarded, and then checking for that information at a later time. For example, when a message is received, the information can be examined to determine whether a potential loop exists and appropriate action may be taken. Also, a message about to be forwarded may be examined to determine whether a potential loop might be created due to its transmission and appropriate action may be taken.

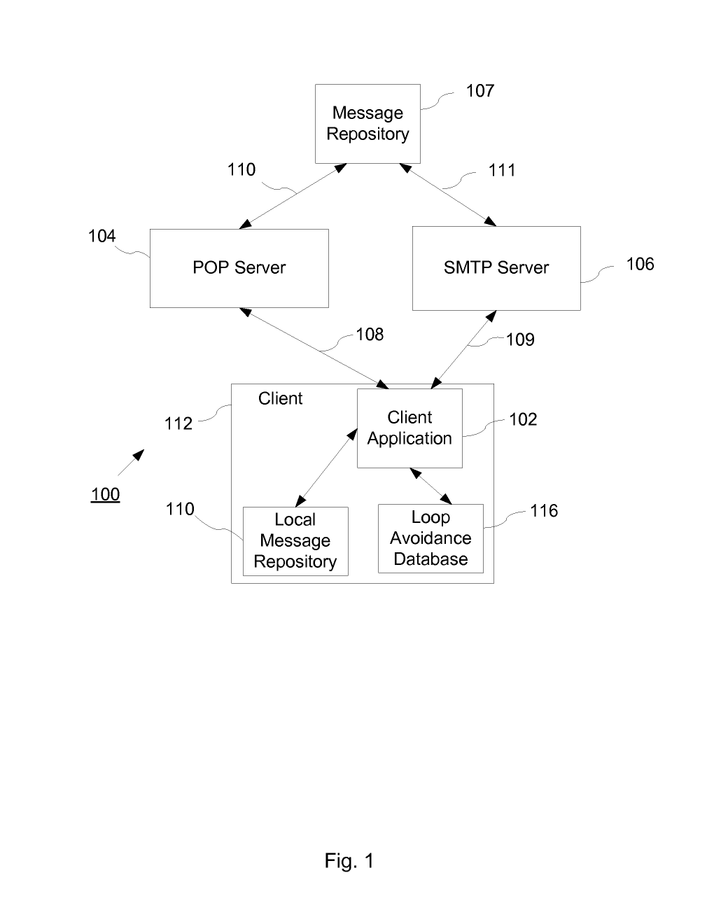

One environment in which embodiments of the invention may operate include clients applications communicating with a POP server. Systems in which a client application can access a POP server may include a client application, a POP server, a Simple Mail Transfer Protocol (SMTP) server and a message repository. As illustrated in FIG. 1, an exemplary system 100 includes a client application 102, a POP server 104, an SMTP server 106 and a message repository 107. The client application 102 communicates with the POP server 104 and the SMTP server 106 via the connections 108 and 109, respectively. The POP server 104 and the SMTP server 108 communicate with the message repository 107 via connections 110 and 111, respectively. The connections 108 through 111 may be provided as network links (physical, optical, wireless or otherwise) on a local area network, a wide area network, the Internet or other type of network, or a combination of such networks. It is sufficient that the connections 108 through 111 permit communication through the use of appropriate protocols.

Although the POP server 104, the SMTP server 106 and the message repository 107 are illustrated as discrete elements in FIG. 1, it should be understood that in some embodiments each may be implemented using multiple servers so as to improve throughput and reliability, cost or other factors, all three could be implemented on the same server, or in various combinations. For instance the SMTP server 106 could be implemented on several distinct servers that communicate with and work in conjunction with each other to enable the functions and features of the SMTP server 106. In another example, the POP server 104 and the SMTP server 106 could be implemented on the same server and the message repository 107 could be implemented on a plurality of servers.

The POP server 104 is a server that permits access to a user's messages stored on message repository 107 using various versions of POP, depending on the version of POP implemented by the POP server 104. POP, according to its various versions, allows a user to download electronic mail messages stored on a remote server via local messaging clients, for example, Outlook, Outlook Express, Eudora, and Mozilla. POP allows a user to work in an off-line mode: the user downloads all his or her messages and then reads them off-line. Although described in relation to POP, it will be readily apparent that the concepts and embodiments described herein will apply equally well to other types of mail access protocols, including but not limited to IMAP.

A user interacts with the client application 102 on a client 112 (sometimes called a client system or client device). The client 112 may be any number of devices including a desktop computer, personal digital assistant (PDA), wireless device, gaming console, internet kiosk, workstation, portable computer, and the like. It is sufficient that the client 112 enable a user to interact with the client application 102 and communicate with the POP server 104 and/or the SMTP server 106, as appropriate.

In some embodiments, the client application 102 is an application (e.g., Outlook, Outlook Express, Eudora, or Mozilla) that interacts with the POP server 104 using POP3 and local message repository 110. It is sufficient that the client application 102 be able to communicate with the POP server 104 or other mail servers using the appropriate protocols. In some embodiments, the client application interacts with multiple POP servers and/or other mail servers which may operate using other protocols. When the client application 102 implements POP, it may interact with the POP server 104 to access messages stored for the user at the message repository 107. For example, using POP3, a client application 102 can download messages from the POP server 104 to the client application 102 for subsequent processing and storage in local message repository 110. A message consists of at least two parts: a header and a body. The header of a message includes such information as the source and destination addresses of the sender and receiver, respectively, of the message as well as other information such as the message subject and certain routing information. The information in the header is provided as a set of tuples, each tuple having a field identifier and field information. For example, a “from” header field would be associated with information indicating the sender of the message and a “to” header field would be associated with information indicating the receiver of the message. The actual names of the fields may vary from protocol to protocol. POP3 provides a “TOP y” command that permits the client application 102 to examine the header of the message and the top y lines of a message stored at the POP server 104. POP3 also provides a “RETR n” command that permits the client application 102 to retrieve a message n stored at the POP server 104, where n is a message identifier provided by the POP server 104. A client application 102 can instruct the POP server 104 to leave a message on the server or to delete it after retrieval.

In some embodiments, the client application 102 can be configured to automatically connect to the POP server 104 and download messages to the client application 102 for possible storage in local message repository 110. A user is typically presented with a number of time periods from which to select for automatic downloading (such as once a day, once an hour, and so on) or the user may enter other time periods or create conditions which trigger a download. The automatic downloading assists the user by reducing the need manually trigger the downloads. In some embodiments, the client application can be configured to download messages from more than one POP server 104 or other remote messaging servers (not shown) using POP or other protocols.

In some embodiments, the client application 102 can be configured to automatically forward messages to destinations based on certain conditions, usually in the form of rules, being met. The forwarding conditions (sometimes herein called the forwarding rules, for convenience) can be user configured or system determined. For example, a rule could be created such that any message received from sender A is automatically forwarded to receiver B. Sender A and receiver B could be any type of messaging accounts, such as electronic mail accounts, for example. Typically, a client application 102 will not allow a user to automatically forward messages to the same account in the same client application 102 (an obvious loop situation). In some embodiments, client application 102 may be configured to forward all received messages to another message account, such as a remote server (not shown). For example, a user may know that he or she will not have access to the particular client 112 at which the client application 102 is located, but may have access to the POP sever 104 via another connection or device (not shown). Accordingly, the user may wish to forward all messages received at the client application 102 to the user's messaging account at the POP server 104. An example of an administrator created rule might be when an administer has all messages received for an employee who is no longer employed sent to a predetermined address. Typically, an SMTP server 106 is associated with a POP mail account so that messages can be sent to and received by that account. SMTP provides protocols for messages to be sent from and to a user's account. The SMTP server 106 and the POP server 104 typically work together on the same repository of messages (such as message repository 107) for a particular message account. In some systems, they are implemented in the same server, although they do not need to be.

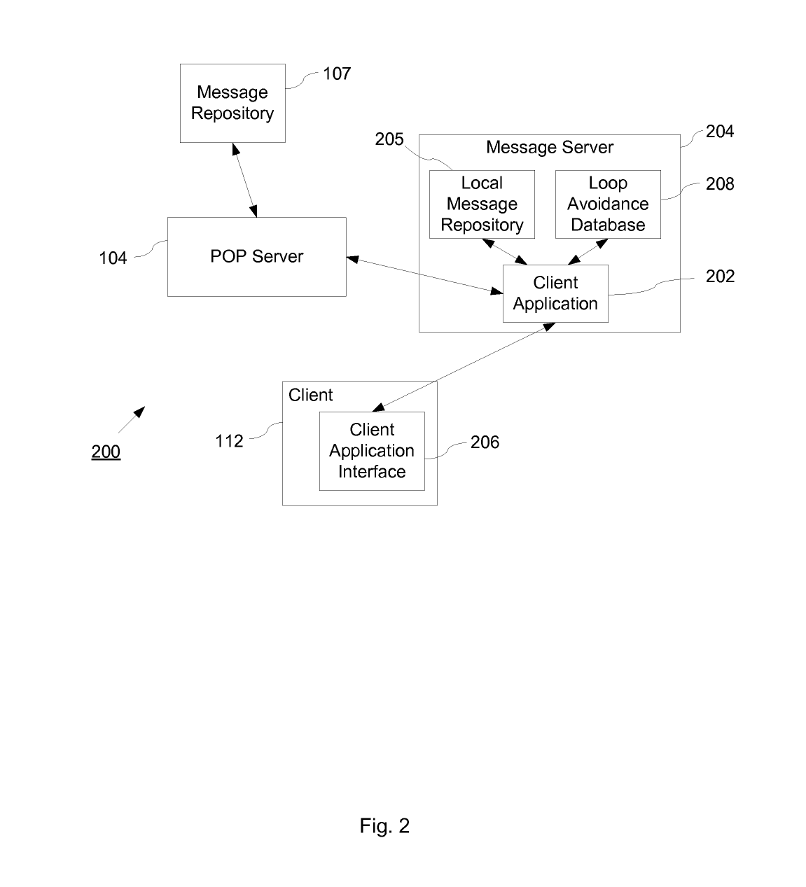

FIG. 2 illustrates another system for communicating with a POP server 104 according to embodiments of the invention. A client application 202 may reside on a message server 204. The client application 202 is used to send and receive messages which are stored at the message server 204 in local message repository 205. It should be understood that in some embodiments the message server 204 may be implemented using multiple servers so as to improve throughput and reliability, cost or other factors. In some embodiments, the client application 202 includes features similar to those described above with reference to client application 102. The client 112 includes a client application interface 206 allowing a user to remotely interact with the client application 202 on the message server 204.

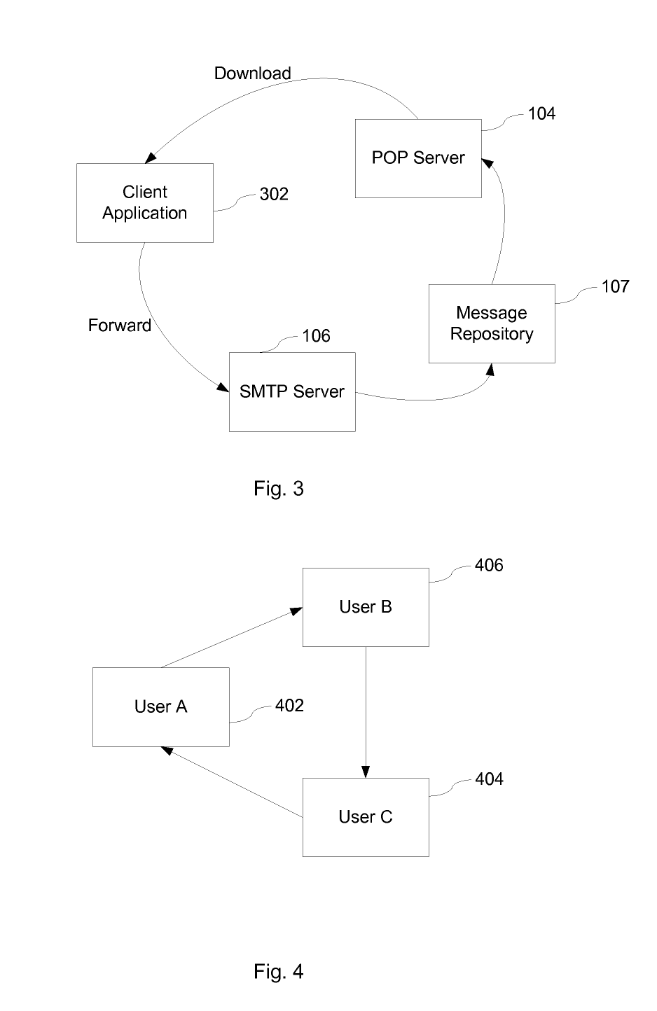

As mentioned earlier, it is possible to create a loop situation between a client application and a POP-type server. Such a loop situation is illustrated in FIG. 3. In this situation, a client application 302 has been configured to automatically forward received messages to the SMTP server 106 account associated with a POP account at the POP server 104. SMTP server 106 stores them in message repository 107. In addition, the client application 302 has been configured to automatically download messages from the POP account at POP server 104 to which the client application 302 is forwarding received messages. As a result, as messages are downloaded to client application 302 from the message repository 107 via POP server 104 they are sent back to the message repository 107 via SMTP server 106, from where they are downloaded again, and so on. In some embodiments, client application 102 and client application 202 are prone to this type of loop situation.

FIG. 4 illustrates another type of loop situation to which all electronic message clients (sometimes called client systems or client devices) and messaging protocols are subject. In this situation, a client application associated with a user A 402 is configured to automatically forward messages received from a user C 404 to a user B 406. As mentioned earlier, the automatic forwarding could be configured by rule based forwarding conditions or rules created by a user, the system or an administrator. Similarly, the client application associated with user B 406 is configured to automatically forward messages received from user A 402 to user C 404. Finally, the client application associated with user C 404 is configured to automatically forward messages received from user B 406 to user A 402. Without some type of intervention, this loop can drain network resources and/or fill up the message repositories associated with the client application associated for users A, B, and C.

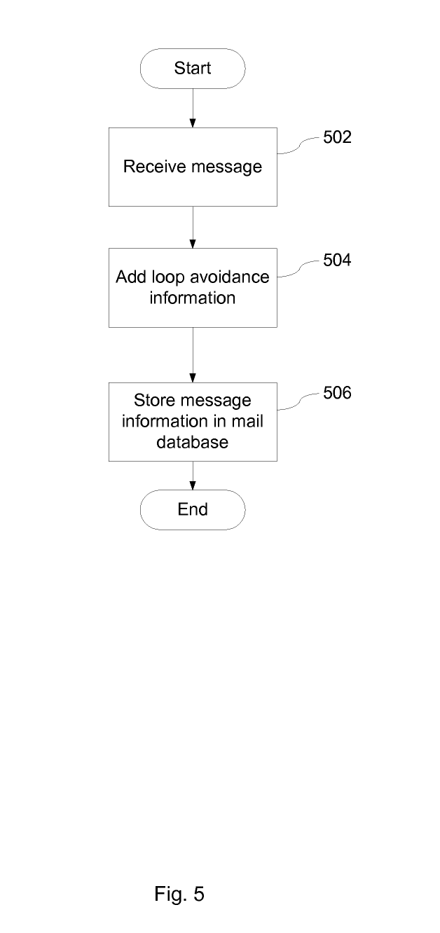

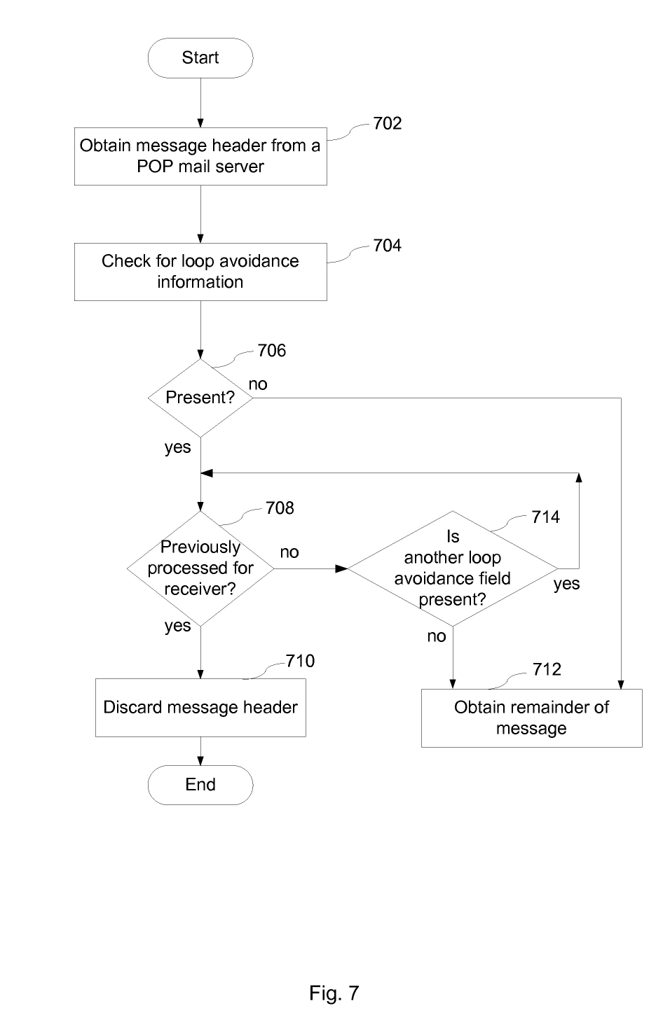

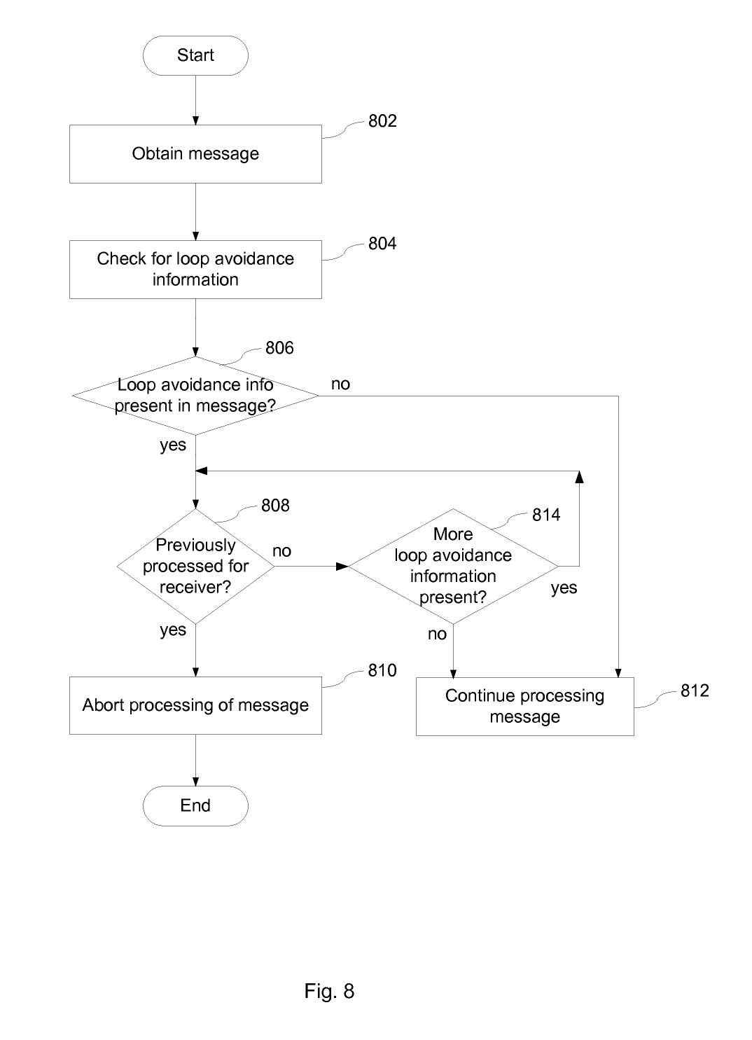

In some embodiments, loop avoidance information is added to a message when it is received by a client application, such as the client application 102, 202. Should the client application 102, 202 see the information again when a new message is received, it will know that it had previously received and processed the message (for a more detailed description, please see the discussion with reference to FIGS. 7 and 8 below). Referring to FIG. 5, after a message is received (502) by a client application 102, 202, loop avoidance information is added to the message (504) before it is stored in the local message repository 110, 205 of the user (506).

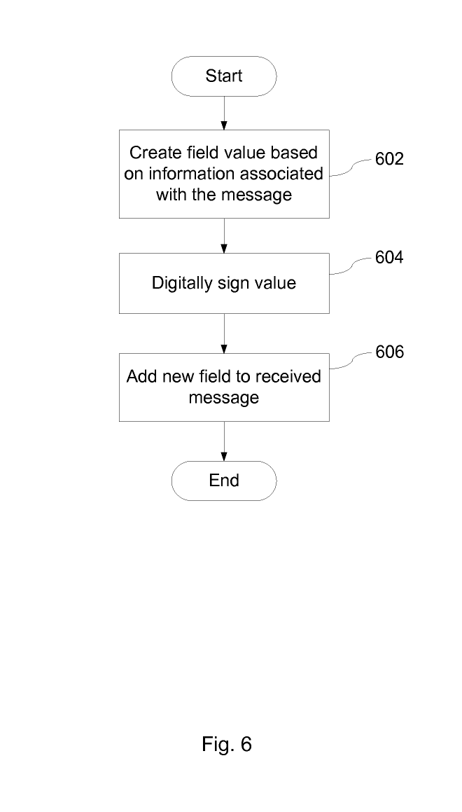

FIG. 6 illustrates in more detail adding loop avoidance information to the message according to some embodiments. The loop avoidance information is added as a new field to the header of the received message. For convenience, we will call this field a loop avoidance field. Although the field itself does not prevent the occurrence of message loops, the insertion of a loop avoidance field in a message can be used to prevent message loops from occurring, as explained more fully below. Although the exact name of the field is not important, the client application 102, 202 uses a name which can be easily identified in subsequent processing by the client application 102, 202. In some embodiments, the loop avoidance field includes the name of the client application. For example, if the name of the client application 102, 202 was foomail, then the field added to the message could be “x-foomail-received”. As another example, if the client application was the Gmail client application available from Google Inc., the field could be “x-gmail-received”. The name of the loop avoidance field is a design choice. It is sufficient that the client application 102, 202 recognize the loop avoidance field when that field is presented to the application as part of a header of a message being processed.

A value for the loop avoidance field is created (602) based on information associated with the message. In some embodiments, the field value includes a user identifier, a message ID and a subject of the message, or the field value includes one or more values derived from the aforementioned information using one or more procedures or functions. In some embodiments the field value is any one or more of the user identifier, the message ID, the subject of the message. In some embodiments, the message ID is a numerical or string value inserted by the application that originally created the message and is found in the header of the message (e.g., <4ca3bbee04092923411ee20ad8@mail.gmail.com>). In some embodiments, the message ID is equivalent to the message-id specified by RFC822 (available from the Internet Engineering Task Force). In some embodiments, the message ID is a numerical or string value determined by the receiving client application 102, 202. In some embodiments, the user identifier is a numerical or string identifier created by the client application 101, 202 and used to identify the receiver of the message. In some embodiments, the user identifier is a string, for example, the email address of the receiver or the user's username. In still further embodiments, the value is based in part on a time/date value of the message as received by the client application 102, 202. In some embodiments, a normalized subject of the message is used (i.e., the subject after removing “re:” or “fwd:” or other similar system added text). Message identifiers alone may be insufficient to identify loops because some mail sending applications may re-use message IDs. In some embodiments a hash function is applied to one or more of the user identifier, message identifier and message subject values in order to produce a value included in the loop avoidance field. For instance, in one embodiment, the loop avoidance field contains three values: the sending user identifier, a message ID, and a hash of the normalized subject of the message. One of ordinary skill in the art will readily recognize other ways to create the field value. In some embodiments, it is sufficient that the receiving client application 102, 202 be able to independently reconstruct the loop avoidance field value from the header of the received message and the user identifier of the receiving user. In some embodiments, a value included in the loop avoidance field is generated by applying a hash function to the contents of the message, instead of basing the value on the subject of the message.

The field value is then digitally signed by the client application 102, 202 using an encryption key (604). In some embodiments, the client application 102, 202 uses a public/private key pair construct (i.e., asymmetric encryption). In a public/private key construct, information encrypted by a user's private key can only be decrypted by the user's public key and vice versa. Preferably, the private key is kept private. If only the encrypter knows the private key, then a recipient using the public key to decrypt encrypted information can be assured that the one holding the private key had encrypted the information. Accordingly, when the client application 102, 202 examines the value in the future, in say, an incoming message, it will be able to determine whether it had encrypted the value previously by being able to decrypt the value using its public key. In some embodiments, the client application 102, 202 uses the same key (i.e., a symmetric key) to both encrypt and decrypt information (i.e., symmetric encryption). Preferably, this key is kept private. Accordingly, when the client application 102, 202 examines the value in the future it will be able to determine whether it had encrypted the value previously by being able to decrypt the value using its key.

The information added to the messages can help to prevent and/or block loops as illustrated in FIG. 7. After the client application 102, 202 establishes a connection with the POP server 104, it obtains one or more message headers, by for example, using the TOP command (702). The header is examined to determine whether any loop avoidance information is present (704). In some embodiments, this is done by determining whether an “x-gmail-received” field is found. As discussed above, the field name is a design choice. If the field is found (706-yes), the field value associated with it is examined (708) to determine whether the client application 102, 202 which is currently processing the header had previously processed the message. If no loop avoidance fields are found (706-no), then the remainder of the message is obtained (712) and normal processing of the message is performed.

At 708, the client application 102, 202 attempts to determine whether it had previously processed the message by examining the field value. In embodiments in which the loop avoidance field contains encrypted information, the client application 102, 202 attempts to decrypt the encrypted value using the appropriate key, such as its public key (if asymmetric encryption was used to encrypt the loop avoidance field value) or its private key (if a symmetric key was used to encrypt the field value). If the decryption is successful, or if the loop avoidance field was not encrypted, the client application 102, 202 examines the information in the loop avoidance field and compares it to the information in the message. For example, the client application 102, 202 may compare a user ID in the field with the user ID of the receiver, the message ID in the field with the message ID of the received message, and subject value in the field with a hash of the normalized subject of the received message. If these values all match, then the client application 102, 202 currently processing the message had previously processed the message and inserted the field and value (i.e., the loop avoidance information) (708-yes). If the values do not match, then the loop avoidance field was not created and inserted by the client application 102, 202 for this user. If the client application 102, 202 previously processed this message (708-yes), then it discards the header (710), thereby blocking retrieval of the message, and continues with other operations. In some embodiments, more than one loop avoidance field may be present in a message (714). In these embodiments, the process for examining the field value is repeated (708, 714) for each loop avoidance field value in the message or until the client application 102, 202 determines (708-yes) that it had previously processed the message for the receiver, in which case the message header is discarded (710) and retrieval of the message is thereby blocked.

If either no loop avoidance information was present (706-no) or the loop avoidance information indicates that it had not previously processed this message (708-no), then the remainder of the message is retrieved and processed (712). In some embodiments, processing the message includes adding the loop avoidance in accordance with FIGS. 5 and 6.

FIG. 8 illustrates a more generalized use of loop avoidance information according to some embodiments. A message is received from any source (802) (not limited to POP servers) and examined for the presence of loop avoidance information (804). If loop avoidance information is present (806-yes) then the field value examined to determine whether the currently processing client application 102, 202 had previously processed the message on behalf of the receiving user (i.e., the user for whom the message is now being processed). It may do this as described above. For example, by examining the field value to match the user identifier, message ID and/or subject. If the client application 102, 202 had previously inserted the field for this user (i.e., the user for whom the message is now being processed) and this message (808-yes) then the message is no longer processed and is discarded (810). On the other hand, if either no loop avoidance information was present (806-no) or the loop avoidance information indicates that it was not inserted by the client application 102, 202 currently processing the message or that the client application 102, 202 currently processing the message for this user had not previously processed this message for this receiver (808-no), then the remainder of the message is retrieved and processed (812). If the loop avoidance information is contained in multiple fields (814) of the message, then each of those fields is processed (808, 814) to determine if any of the fields indicate that the message was previously processed by the client application for this user, until either all such fields have been processed (814-no) or a match is found (808-yes).

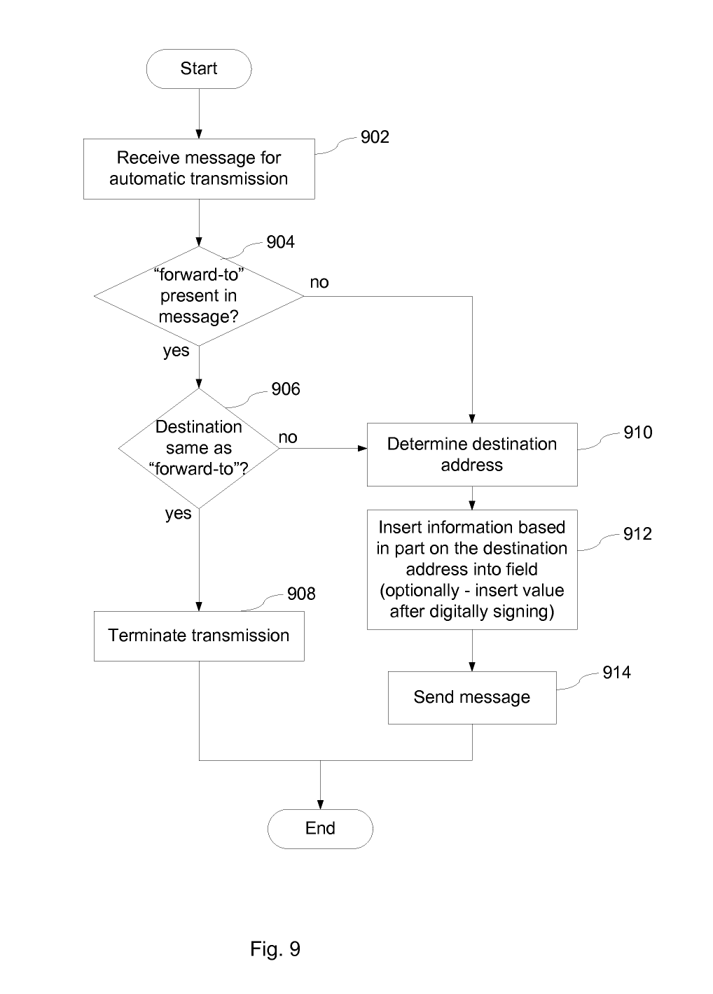

In some embodiments loop avoidance information is added to a message when a message is being automatically forwarded. Referring to FIG. 9, when a client application 102, 202 is processing a message for automatic forwarding to a specified forwarding address (902), it examines the message for loop avoidance information indicating that it had previously forwarded message to the same address as the specified forwarding address. In some embodiments, it looks for an “X-Forwarded-To” field (although the exact name of the field is a design choice) which holds the address to which a message had been forwarded, previously inserted by the sending client application 102, 202. If it finds the “X-Forwarded-To” field (904-yes), the client application 102, 202 determines whether the information in the field indicates previous forwarding to the same address by the client application. In one embodiment, this is indicated when the specified forwarding address (to which the client application 102, 202 is to automatically forward the instant message) is the same as the value in the “X-Forwarded-To” field. If the addresses are the same (906-yes), then the forwarding of the current message is terminated (908), because the client application 102, 202 had previously forwarded this message to the same addressee and should not do it again. More generally, if the information in the “X-Forwarded-To” field matches a predefined forwarding termination condition (which will generally include a forwarding address in the field that matches the currently specified forwarding address) then the transmission of the message is terminated at 908. If the message contains multiple “X-Forwarded-To” fields, then each such field is inspected at 906 until either a field is found that matches the forwarding termination condition, or all such fields have been inspected.

In some embodiments, the forwarding termination condition is simply a match of the address in any “X-Forwarded-To” field of a message with the currently specified forwarding address, without regard to the identify of the current message sending user (for whom the message is being automatically forwarded to the specified forwarding address). In other embodiments, the forwarding termination condition also includes a requirement that the prior sending user identified in a “X-Forwarded-To” field of the message match the current message sending user.

The “X-Forwarded-To” field could contain other information as well. In some embodiments, the field could also contain one or more of the user identifier of the sender who automatically forwarded the message, the message ID and the subject of the message, hashes of one or more of those values, or combinations thereof. In some embodiments, the “X-Forwarded-To” field is digitally signed as described above, and then decrypted to determine whether the client application 102, 202 which had inserted the “X-Forwarded-To” value is the same as the instant client application 102, 202 currently forwarding the message as described above.

If no loop avoidance information is present (e.g., in the form of “X-Forwarded-To” field) (904-no) or the loop avoidance information does not include information indicating previous forwarding of the message to the same address (906-no), then loop avoidance information (e.g., in the form of “X-Forwarded-To” field) is added to the message prior to transmission. To create the field value, the addressee of the message to where the message is being automatically forwarded is obtained (910) and inserted into a header field of the message (912). In some embodiments, the user identifier of the sender is additionally inserted into the field. In some embodiments, additional information may be added to assist in subsequent identification of the message, such as the subject (or a normalized version of the subject) and/or message ID. In some embodiments, the value inserted in the header field is obtained by applying a hash function or other mapping function to one or more of the aforementioned values. In some embodiments, the field can be encrypted and/or digitally signed as described above. In the event that the same client application 102, 202 is requested to automatically forward the same message again to the same forwarding address, the client application will be able to use that information to abort or block the message forwarding operation. Finally, the message is sent to the addressee (914).

Both the “x-gmail-received” field and the “X-Forwarded-To” field described above are examples of loop avoidance fields added to messages in order to enable a client application or messaging application to block the looping of forwarded messages.

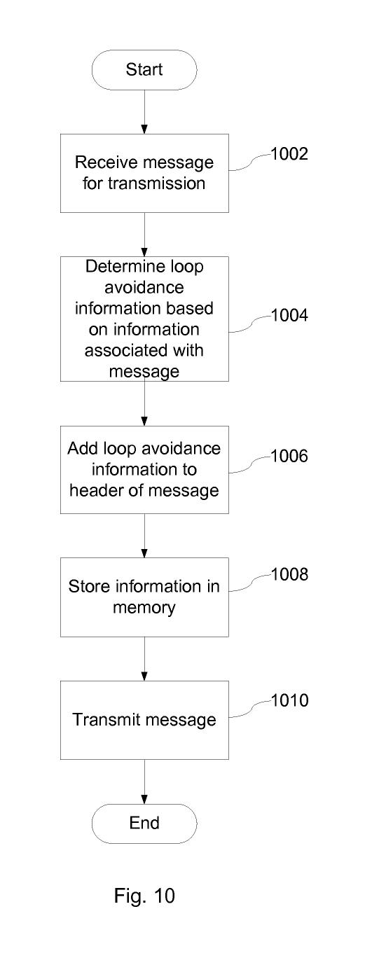

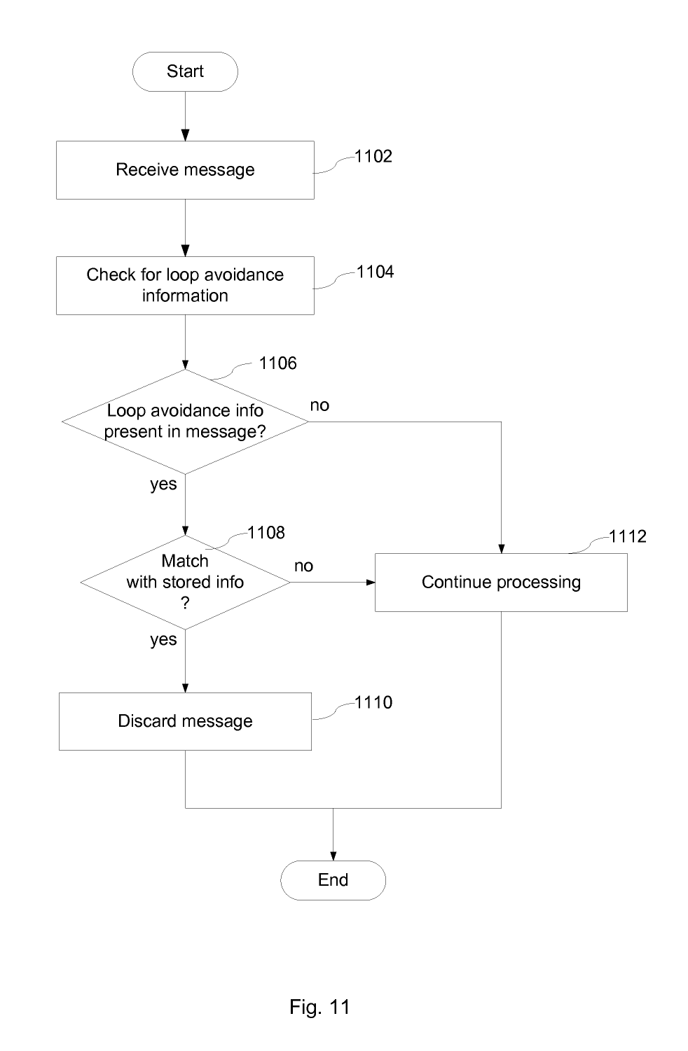

In some embodiments loop avoidance information based on information associated with the message is added when a message is transmitted. Referring to FIG. 10, when a message is received for transmission (1002) (of any type—regular or automatic), loop avoidance information is determined based on information associated with the message (1004). In some embodiments, the loop avoidance information includes the sending user identifier, the message ID and the subject (or a normalized version of the subject) of the message (1004), or combinations and hashes thereof similar to that described earlier. In some embodiments, the field could be digitally signed as described above. The loop avoidance information may be stored in a database (1008) to allow subsequent look up of that information. In some embodiments, a hash of the loop avoidance information is stored in a hash table or index to assist in fast look up of the loop avoidance information. One of ordinary skill in the art will recognize various permutations of the processing described above to achieve the same result. For example, if the values stored in the field are not hashed, but the information stored in the database is hashed, then the client application 102, 202 could hash the information in a received message currently being processed prior to performing a look up. Alternatively, the loop avoidance information could be stored (e.g., in a message server, or in a client computer) at a location within a table or database, wherein the location is associated with the sending user identifier, the addressee's user identifier, or a combination of the sending user identifier and the addressee's user identifier.

Finally, the message is transmitted (1010). As with many of the processes described herein, the order of the processing laid out in the figures is illustrative and the processing may be ordered in other ways in other embodiments, to the extent that such ordering is consistent with achieving correct results. For example, while the storing of the information (1008) is shown in FIG. 10 as occurring prior to the transmission of the message (1010), it could occur after or both could be executed substantially in parallel.

When a message is received by a client application, the message is examined in accordance with FIG. 11 to determine whether the same message was previously transmitted by the same user as the current user. The message is received (1102) and examined for loop avoidance information (1104) in the form described above in reference to FIG. 10. If the loop avoidance information is present (1106-yes) the loop avoidance information is checked against the loop avoidance information previously stored by the client application 102, 202, in, for example, loop avoidance database 116, 208. In some embodiments, this may include decrypting the loop avoidance information. If the loop avoidance information matches loop avoidance information previously stored by the client application (1108-yes), then the client application 102, 202 previously transmitted the message and the receipt processing of the message is aborted (1110). In one embodiment, the matching condition that must be met in order to satisfy the match test at 1108 includes matching the user identifier (i.e., matching the prior sender and current recipient), the message ID and the subject of the message. When a newly received message is initially processed, the loop avoidance information is extracted from the message and then the previously stored loop avoidance information is searched for the presence of matching loop avoidance information. If matching loop avoidance information is found, then the message had been previously processed and sent by the client application 102, 202. On the other hand if no loop avoidance information is present in the message (1106-no) or that the loop avoidance information does not match the previously stored loop avoidance information (1108-no), then message receipt processing continues (1112).

Although some of various drawings illustrate a number of logical stages in a particular order, stages which are not order dependent may be reordered and other stages may be combined or broken out in other embodiments. Moreover, it should be recognized that the stages can be implemented in hardware, firmware, software or any combination thereof

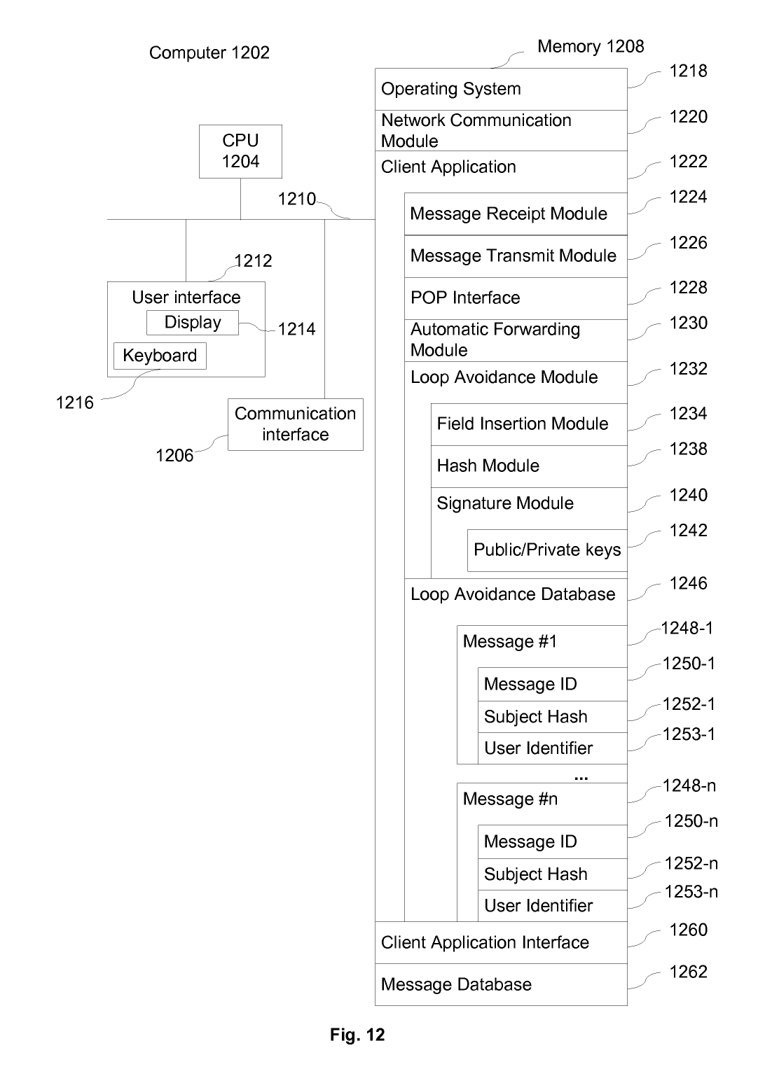

Referring to FIG. 12, an embodiment of a computer system 1202 (sometimes called a message client system) that implements the methods described above includes one or more processing units (CPU's) 1204, one or more network or other communications interfaces 1206, memory 1208, and one or more communication buses 1210 for interconnecting these components. The computer 1202 may optionally include a user interface 1212. The user interface 1212 may optionally include a display device 1214 (e.g., for displaying system status information) and/or a keyboard 1216 (e.g., for entering commands). Memory 1208 may include high speed random access memory and may also include non-volatile memory, such as one or more magnetic or optical storage disks. Memory 1208 may optionally include mass storage that is remotely located from CPU's 1204. Memory 1208, or alternatively one or more storage devices (e.g., one or more nonvolatile storage devices) within memory 1208, included a computer readable storage medium. Memory 1208 or the computer readable storage medium of memory 1208 may store:

an operating system 1218 that include procedures for handling various basic system services and for performing hardware dependent tasks;
a network communication module (or set of instructions) 1220 that is used for connecting the computer 1202 to other computers via the one or more communications network interfaces 1206 (wired or wireless), such as the Internet, other wide area networks, local area networks, metropolitan area networks, and so on;
a client application module (or set of instructions) 1222 that interfaces with various mail servers and the user as described above, and including modules, instructions and data structures, or a subset thereof:

a message receipt module (or instructions) 1224 for receiving and processing messages as described above;

a message transmit module (or instructions) 1226 for processing and transmitting message as described above;

a POP interface 1228 for interfacing with POP servers as described above, an automatic forwarding module (or instructions) 1230 for handling configuration of and transmission of messages in accordance with automatic transmission criteria as described above;

a loop avoidance module (or instructions) 1232 for creating and using loop avoidance information as described above, including a field insertion module (1234) for inserting fields into messages; the loop avoidance module or instructions may optionally include a hash module or instructions (1238) for calculating hashes of certain information, a signature module or instructions 1240, including one or more keys 1242 for encrypting and decrypting certain information; and

a loop avoidance database 1246 for storing certain loop avoidance information as described above, including, a loop avoidance information 1248 for each of a plurality of messages, which in one embodiment includes a message ID 1250, a subject 1252 and user identifier 1253, for each respective message for which loop avoidance information has been stored;

a client application interface 1260 for interfacing with the client application as described above; and
a message database 1262 for storing message as described above.

Some embodiments may implement only a subset of the loop avoidance mechanisms described above. For instance, in one embodiment a mechanism for blocking the receipt of messages previously received by the same user is implemented, but a mechanism for preventing the forwarding of a message that has already been forwarded to the same addressee is not implemented. In another embodiment, a mechanism for preventing the forwarding of a message that has already been forwarded to the same addressee is implemented, but a mechanism for blocking the receipt of messages previously received by the same user is not implemented. In yet another embodiment, both of these types of loop avoidance mechanism are implemented, but without implementing a loop avoidance database.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

1. A method of avoiding message loops, comprising:
at a message client system including one or more processors and memory:
retrieving from a message server a first portion of a message stored at the message server;
prior to retrieving a second portion of the message, determining the existence of loop avoidance information previously created by the message client system in the first portion; and
automatically, without user intervention:
in accordance with a determination that a first condition is satisfied, retrieving the second portion of the message; and
in accordance with a determination that a second condition is satisfied, forgoing retrieval of the second portion of the message.

2. The method of claim 1, wherein:
the first condition is satisfied when no loop avoidance information exists that was previously created by the message client system; and
the second condition is satisfied when the loop avoidance information indicates that the message was previously received by the message client system.

3. The method of claim 2, wherein the loop avoidance information includes a value calculated based on a user identifier.

4. The method of claim 3, wherein the value was digitally signed using an encryption key.

5. The method of claim 3, wherein the value is a function of at least the user identifier and a message identifier.

6. The method of claim 3, wherein the value is a function of at least the user identifier and the portion of a subject of the message.

7. The method of claim 1, wherein:
the first condition is satisfied when no loop avoidance information exists that was previously created by the message client system; and
the second condition is satisfied when the loop avoidance information indicates that the message was previously forwarded by the message client system.

8. A non-transitory computer readable storage medium storing one or more programs, the one or more programs comprising instructions, which when executed by a message client system with one or more processors, cause the message client system to:
retrieve from a message server a first portion of a message stored at the message server;
prior to retrieving a second portion of the message, determine the existence of loop avoidance information previously created by the message client system in the first portion; and
automatically, without user intervention:
in accordance with a determination that a first condition is satisfied, retrieve the second portion of the message; and
in accordance with a determination that a second condition is satisfied, forgo retrieval of the second portion of the message.

9. The non-transitory computer readable storage medium of claim 8, wherein:
the first condition is satisfied when no loop avoidance information exists that was previously created by the message client system; and
the second condition is satisfied when the loop avoidance information indicates that the message was previously received by the message client system.

10. The non-transitory computer readable storage medium of claim 9, wherein the loop avoidance information includes a value calculated based on a user identifier.

11. The non-transitory computer readable storage medium of claim 10, wherein the value was digitally signed using an encryption key.

12. The non-transitory computer readable storage medium of claim 10, wherein the value is a function of at least the user identifier and a message identifier.

13. The non-transitory computer readable storage medium of claim 10, wherein the value is a function of at least the user identifier and the portion of a subject of the message.

14. The non-transitory computer readable storage medium of claim 8, wherein:
the first condition is satisfied when no loop avoidance information exists that was previously created by the message client system; and
the second condition is satisfied when the loop avoidance information indicates that the message was previously forwarded by the message client system.

15. A message client system for avoiding message loops, comprising:
one or more processors;
memory; and
one or more programs, wherein the one or more programs are stored in the memory and configured to be executed by the one or more processors, the one or more programs including instructions for:
retrieving from a message server a first portion of a message stored at the message server;
prior to retrieving a second portion of the message, determining the existence of loop avoidance information previously created by the message client system in the first portion; and
automatically, without user intervention:
in accordance with a determination that a first condition is satisfied, retrieving the second portion of the message; and
in accordance with a determination that a second condition is satisfied, forgoing retrieval of the second portion of the message.

16. The message client system of claim 15, wherein:
the first condition is satisfied when no loop avoidance information exists that was previously created by the message client system; and
the second condition is satisfied when the loop avoidance information indicates that the message was previously received by the message client system.

17. The message client system of claim 16, wherein the loop avoidance information includes a value calculated based on a user identifier.

18. The message client system of claim 17, wherein the value was digitally signed using an encryption key.

19. The message client system of claim 17, wherein the value is a function of at least the user identifier and a message identifier.

20. The message client system of claim 17, wherein the value is a function of at least the user identifier and the portion of a subject of the message.

21. The message client system of claim 15, wherein:
the first condition is satisfied when no loop avoidance information exists that was previously created by the message client system; and
the second condition is satisfied when the loop avoidance information indicates that the message was previously forwarded by the message client system.
